(19) United States
(12) Patent Application Publication
(10) Pub. No.: US 2024/0030538 A1
(43) Pub. Date: Jan. 25, 2024

(54) BATTERY UNIT, BATTERY UNIT ASSEMBLY, POWER TOOL, AND ELECTRIC VEHICLE

(71) Applicant: MURATA MANUFACTURING CO., LTD., Kyoto (JP)

(72) Inventors: Kenichi OZAWA, Kyoto (JP); Masaki KURATSUKA, Kyoto (JP); Josh CHIANG, Kyoto (JP); Ken CHEN, Kyoto (JP)

(21) Appl. No.: 18/371,019

(22) Filed: Sep. 21, 2023

Related U.S. Application Data
(63) Continuation of application No. PCT/JP2022/019835, filed on May 10, 2022.

(30) Foreign Application Priority Data
Jun. 28, 2021 (JP) 2021-106317

(51) Int. Cl. H01M 50/242; H01M 50/202; H01M 50/224; H01M 50/211; H01M 50/264

(52) U.S. Cl. CPC H01M 50/242; H01M 50/202; H01M 50/224; H01M 50/211; H01M 50/264; H01M 2220/30; H01M 2220/20

(57) ABSTRACT

A battery unit includes a battery cell, and a metal case in which a battery cell is stored, the metal case including a bottom surface, and a first side wall and a second side wall erected from a peripheral edge of the bottom surface and having inner surfaces opposing each other, in which the first side wall and the second side wall protrude further than an upper surface of the battery cell, and a distance between an inner surface of the first side wall and an inner surface of the second side wall is larger on an end side, which is an opposite side to a bottom surface side, than on the bottom surface side.

### CROSS REFERENCE TO RELATED APPLICATIONS

The present application is a continuation of PCT patent application no. PCT/JP2022/019835, filed on May 10, 2022, which claims priority to Japanese patent application no. 2021-106317, filed on Jun. 28, 2021, the entire contents of which are incorporated herein by reference.

### BACKGROUND

The present application relates to a battery unit, a battery unit assembly, a power tool, and an electric vehicle.

Cases storing batteries (battery modules) such as lithium ion batteries or the like are connected on multiple stages to increase output of a battery pack. For example, an assembly of battery modules is described in which the battery modules are stacked in a vertical direction and are electrically connected.

### SUMMARY

The present application relates to a battery unit, a battery unit assembly, a power tool, and an electric vehicle.

The technique described in Background section is insufficient as a technique for preventing positional displacement of a battery module due to vibration or impact applied to the battery module without a projecting part on the case of the battery module being involved in restraining the battery module. In addition, since a large clearance is present between the projecting part on the case and a bottom portion of the battery module arranged on an upper stage, there is a problem in that the battery module is greatly displaced by vibration or impact.

Consequently, the present disclosure relates to providing, in an embodiment, a battery unit assembly having improved vibration resistance and impact resistance, and battery units constituting the battery unit assembly. In addition, another object of the present disclosure is to provide a power tool and an electric vehicle having the battery unit or the battery unit assembly described above.

The present application relates to, in an embodiment, a battery unit including a battery cell and a metal case in which the battery cell is stored, the metal case including a bottom surface, and a first side wall and a second side wall erected from a peripheral edge of the bottom surface and each having inner surfaces opposing each other, wherein the first side wall and the second side wall protrude further than an upper surface of the battery cell, and a distance between the inner surface of the first side wall and the inner surface of the second side wall is larger on an end side, which is an opposite side to a bottom surface side, than on the bottom surface side.

The present application, in an embodiment, further relates to a battery unit assembly including a plurality of the battery units described above, wherein a first battery unit and a second battery unit among the plurality of battery units are stacked, a part of a first side wall of the first battery unit and a part of a first side wall of the second battery unit overlap, and a part of a second side wall of the first battery unit and a part of a second side wall of the second battery unit overlap.

According to at least an embodiment, a battery unit or the like having improved vibration resistance and impact resistance can be provided. Note that the contents of the present disclosure should not be understood as being limited by the effects exemplified in the present specification.

### BRIEF DESCRIPTION OF THE FIGURES

FIG. 1 is a perspective view of a battery unit according to an embodiment.

FIG. 2 is a perspective view of the battery unit according to an embodiment.

FIG. 3 is an exploded perspective view of the battery unit according to an embodiment.

FIG. 4 is a diagram to be referred to when details of the battery unit according to an embodiment are described.

FIG. 5 is a diagram to be referred to when details of the battery unit according to an embodiment are described.

FIG. 6 is a diagram to be referred to when details of the battery unit according to an embodiment are described.

FIG. 7 is a diagram to be referred to when details of the battery unit according to an embodiment are described.

FIG. 8 is a diagram to be referred to when details of the battery unit according to an embodiment are described.

FIG. 9 is a diagram to be referred to when details of the battery unit according to an embodiment are described.

FIG. 10 is a diagram to be referred to when another type of battery unit is described.

FIG. 11 is a diagram to be referred to when the other type of battery unit is described.

FIG. 12 is a diagram to be referred to when the other type of battery unit is described.

FIG. 13 is a diagram to be referred to when the other type of battery unit is described.

FIG. 14 is a diagram to be referred to when the other type of battery unit is described.

FIG. 15 is a diagram to be referred to when the other type of battery unit is described.

FIG. 16 is a diagram to be referred to when a first side wall and a second side wall according to an embodiment are described.

FIGS. 17A and 17B are diagrams to be referred to when the first side wall and the second side wall according to an embodiment are described.

FIG. 18 is a diagram to be referred to when a third side wall according to an embodiment is described.

FIG. 19 is a diagram to be referred to when a battery unit assembly according to an embodiment is described.

FIG. 20 is a diagram to be referred to when the battery unit assembly according to an embodiment is described.

FIG. 21 is a diagram for describing an example of an electrical connection mode of each battery unit constituting the battery unit assembly according to an embodiment.

FIG. 22 is a diagram for describing another example of an electrical connection mode of each battery unit constituting the battery unit assembly according to an embodiment.

FIG. 23 is a diagram for describing an example of overlapping positions according to an embodiment.

FIG. 24 is a diagram for describing a first example of a holding member.

FIG. 25 is a diagram for describing the first example of the holding member.

FIG. 26 is a diagram for describing the first example of the holding member.

FIG. 27 is a diagram for describing a second example of the holding member.

FIGS. 28A and 28B are diagrams for describing a third example of the holding member.

FIGS. 29A and 29B are diagrams for describing a fourth example of the holding member.

FIGS. 30A and 30B are diagrams for describing a fifth example of the holding member.

FIG. 31 is a diagram for describing an example of fixing a plurality of battery units using a laser.

FIG. 32 is a diagram for describing an application example of the present disclosure.

FIG. 33 is a diagram for describing an application example of the present disclosure.

### DETAILED DESCRIPTION

Hereinafter, one or more embodiments of the present disclosure will be described in further detail below with reference to the drawings.

While one or more embodiments including examples of the present disclosure are described herein, the contents of the present disclosure are not limited thereto.

The present disclosure is not intended to be limited to only the dimensions, materials, and shapes of the constituent members described in the embodiment, relative arrangements thereof, and descriptions of directions such as upward, downward, leftward, and rightward, which are merely description examples. Note that sizes, positional relationships, and the like of the members illustrated in each drawing may be exaggerated in order to make the description clearer, and further, only some of the reference numerals may be illustrated, or a part of the illustration may be simplified, in order to prevent complicating illustrations. Moreover, in the following description, the same names and reference numerals represent identical members or members having the same quality, and redundant descriptions thereof are omitted as appropriate. Furthermore, for each element constituting the present disclosure, a mode in which one member serves as a plurality of elements made of the same member may be employed, or conversely, the function of one member can be distributed among and realized by a plurality of members.

In the present specification, a configuration in which battery cells (unit cells) are stored in a metal case is referred to as a battery unit, and a configuration in which a plurality of battery units is provided is referred to as a battery unit assembly. A configuration in which a control board mounted with a control integrated circuit (IC) performing a protection operation and the like for a battery unit is connected to a battery unit assembly, is referred to as a battery pack.

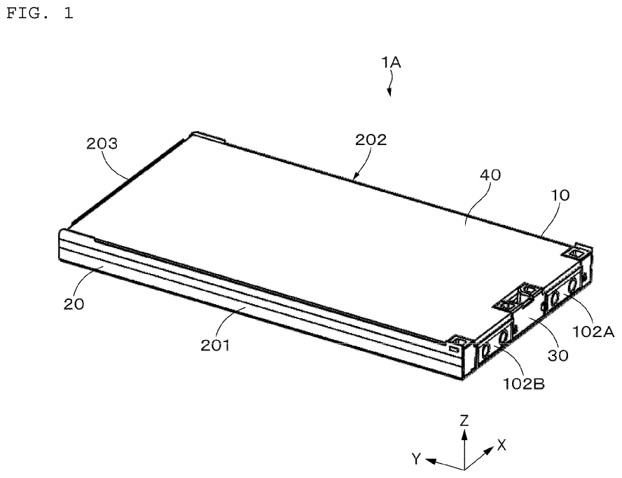

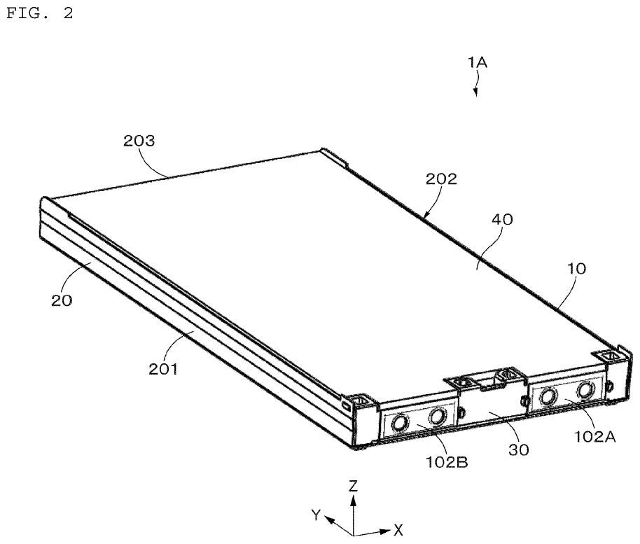

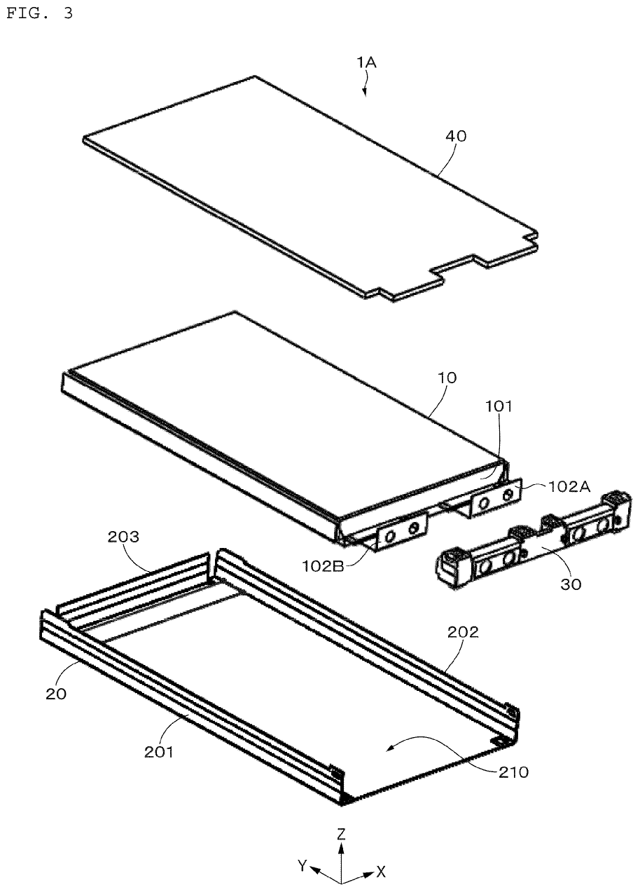

First, a configuration example of a battery unit according to the present embodiment will be described with reference to FIGS. 1 to 3. In the present embodiment, there are two types of battery units (battery units 1A, 1B). First, a battery unit 1A will be described. FIGS. 1 and 2 are perspective views of the battery unit 1A according to the embodiment. In addition, FIG. 3 is an exploded perspective view of the battery unit 1A.

The battery unit 1A has a substantially cuboid shape. In the following description, unless otherwise specified, a lateral direction of the battery unit 1A is referred to as an X direction, a longitudinal direction of the battery unit 1A is referred to as a Y direction, and a height direction of the battery unit 1A is referred to as a Z direction, as appropriate. In addition, a side (also referred to as a terrace) of an end surface (a surface on which a later-described positive electrode tab and negative electrode tab are exposed) arranged on a −Y direction side of the battery unit 1A is referred to as a top side, and an end surface arranged on a +Y direction side (the end surface opposite to the top side) is referred to as a bottom side, as appropriate. Moreover, a −Z direction is referred to as a bottom surface, a bottom portion, or a lower side, and a +Z direction is referred to as an upper surface or an upper side, as appropriate.

The battery unit 1A includes a battery cell 10, a metal case 20, a holder 30, and a cushion member 40.

The battery cell 10 has a substantially cuboid shape. The battery cell 10 is, for example, a laminate type lithium ion battery cell. A publicly known configuration may be applied as the battery cell 10.

An example of the battery cell 10 will be schematically described. A positive electrode and a negative electrode are arranged so as to oppose each other with a separator interposed therebetween, and are wound (or may be laminated) to form a battery element. After a positive electrode tab (positive electrode terminal) and a negative electrode tab (negative electrode terminal) are attached to the battery element, the battery element is sealed inside a film-like exterior member. For example, a laminate film having a rectangular shape and obtained by bonding a nylon film, an aluminum foil, and a polyethylene film in this order can be used as the exterior member. As illustrated in FIG. 3, in the battery cell 10 having such a configuration, a positive electrode tab 102A and a negative electrode tab 102B are derived from a bottom portion side of a top side end surface 101. The positive electrode tab 102A and the negative electrode tab 102B are each made of, for example, a metal material such as aluminum (Al), copper (Cu), nickel (Ni), stainless steel, or the like.

The metal case 20 is a member that stores the battery cell 10. For the metal case 20, aluminum, copper, or the like can be used. The metal case 20 includes a bottom surface 210 having a substantially rectangular shape in a plan view. Three side walls are erected from a peripheral edge part of the bottom surface 210. Specifically, a first side wall 201 and a second side wall 202 are erected extending upward from the peripheral edge of the bottom surface 210 in the longitudinal direction. An inner surface of the first side wall 201 (a surface positioned on an inner side of the metal case 20) and an inner surface of the second side wall 202 oppose each other. In addition, the metal case 20 includes a third side wall 203 extending in a direction (the X direction in the present example) substantially orthogonal to an extending direction (the Y direction in the present example) of the first side wall 201 and the second side wall 202. The third side wall 203 is erected extending upward from a peripheral edge of a bottom side of the bottom surface 210 in the lateral direction.

The holder 30 is a member attached to a top side of the battery cell 10. The holder 30 is attached to the metal case 20 to hold the battery cell 10. The holder 30 is made of, for example, resin.

The cushion member 40 is attached to an upper surface of the battery cell 10. The cushion member 40 is an elastic, rectangular thin plate-shaped member, and is a member that protects the battery cell 10 from impact, vibration, or the like.

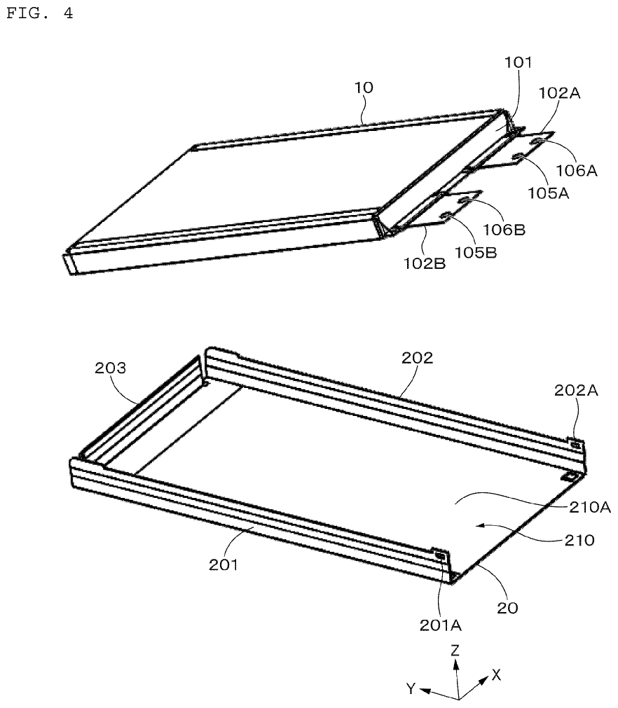

Next, the details of the battery unit 1A will be described with reference to FIGS. 4 to 9, in addition to FIGS. 1 to 3. Note that in the following description, an example of a manufacturing method for the battery unit 1A will also be mentioned as appropriate.

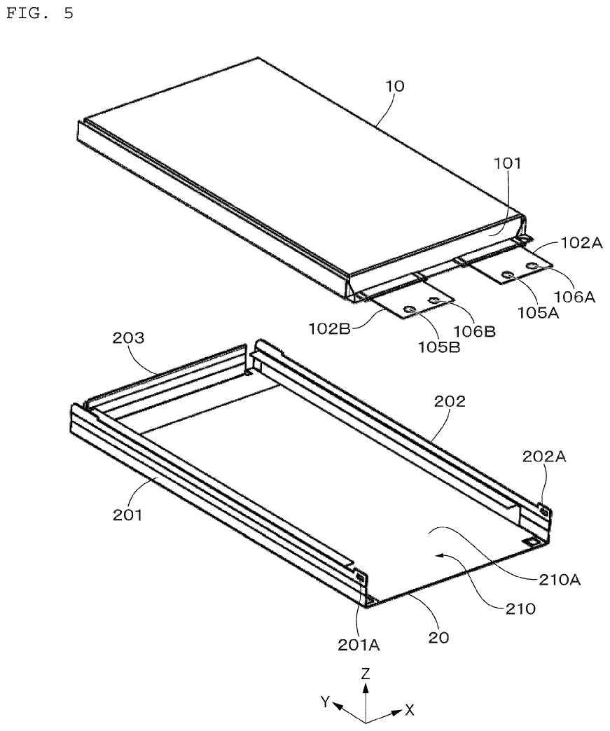

As illustrated in FIGS. 4 and 5, the positive electrode tab 102A and the negative electrode tab 102B are derived from the top side end surface 101 of the battery cell 10. The positive electrode tab 102A and the negative electrode tab 102B are derived in a flat state without being bent. The positive electrode tab 102A includes holes 105A and 106A having a substantially circular shape. The negative electrode tab 102B includes holes 105B and 106B having a substantially circular shape.

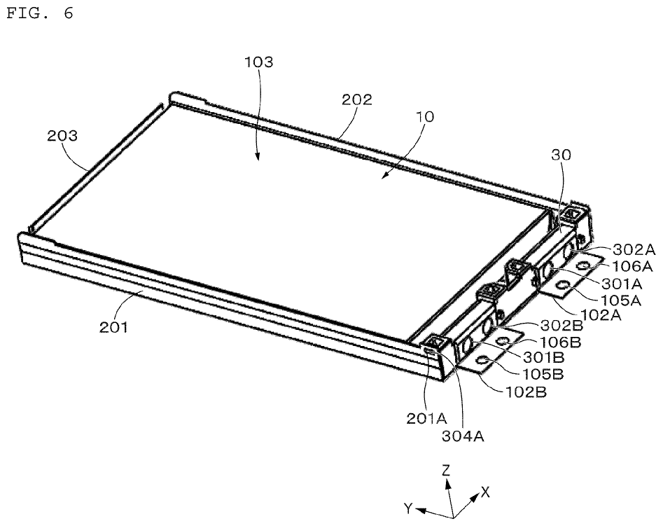

In addition, as illustrated in FIGS. 4 and 5, a double-sided tape 210A is provided on the bottom surface 210 of the metal case 20. When the battery cell 10 is stored in the metal case 20, the double-sided tape 210A is stuck to a bottom surface of the battery cell 10. In a state where the battery cell 10 is fixed to the metal case 20 by the double-sided tape 210A, the holder 30 is attached to the top side of the battery cell 10 (see FIG. 6).

As illustrated in FIG. 7, the holder 30 has an approximately quadrangular prism shape including irregularities. The holder 30 includes four holes 301A, 302A, 301B, and 302B provided along the X direction. The holes 301A, 302A, 301B, and 302B each have a substantially circular shape. In addition, a claw 304A and a claw 305A are provided on both side surfaces of the holder 30 in the X direction. For example, the claw 304A is fitted into a hole 201A (see FIGS. 4 and 5) provided in the first side wall 201. In addition, for example, the claw 305A is fitted into a hole 202A (see FIGS. 4 and 5) provided in the second side wall 202. In this way, the metal case 20 and the holder 30 are integrated together (see FIG. 6).

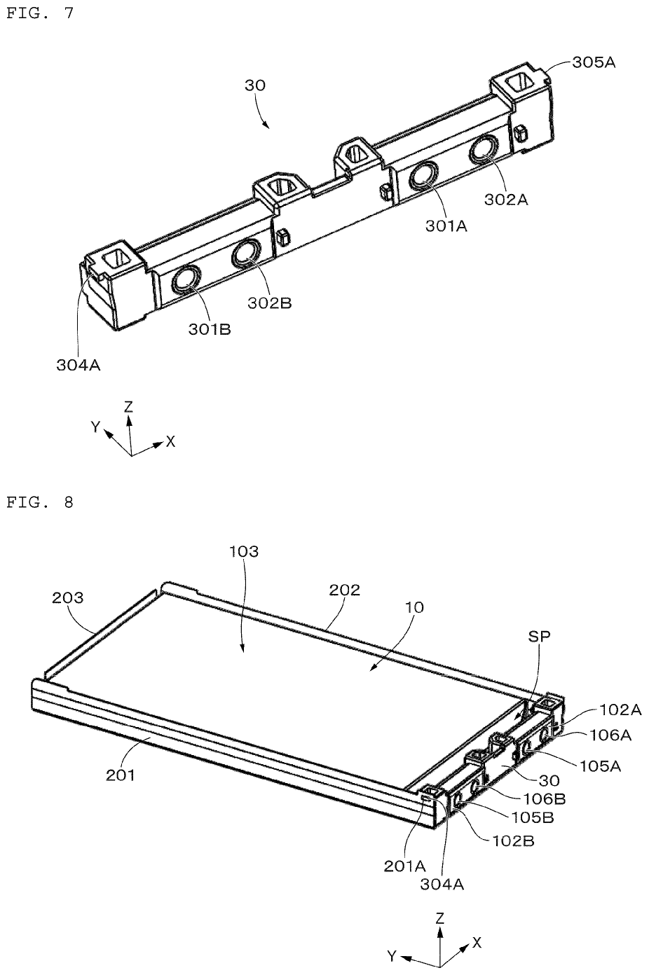

After the holder 30 is attached, the positive electrode tab 102A and the negative electrode tab 102B are bent. For example, the positive electrode tab 102A and the negative electrode tab 102B are bent upward by approximately 90 degrees. In a state where the positive electrode tab 102A and the negative electrode tab 102B are bent, the holes of the tabs and the holes of the holder 30 are positioned overlapping each other. Specifically, the hole 105A of the positive electrode tab 102A and the hole 301A of the holder overlap each other, and the hole 106A of the positive electrode tab 102A and the hole 302A of the holder 30 overlap each other. In addition, the hole 105B of the negative electrode tab 102B and the hole 301B of the holder overlap each other, and the hole 106B of the negative electrode tab 102B and the hole 302B of the holder 30 overlap each other. FIG. 8 illustrates a state where the positive electrode tab 102A and the negative electrode tab 102B are bent.

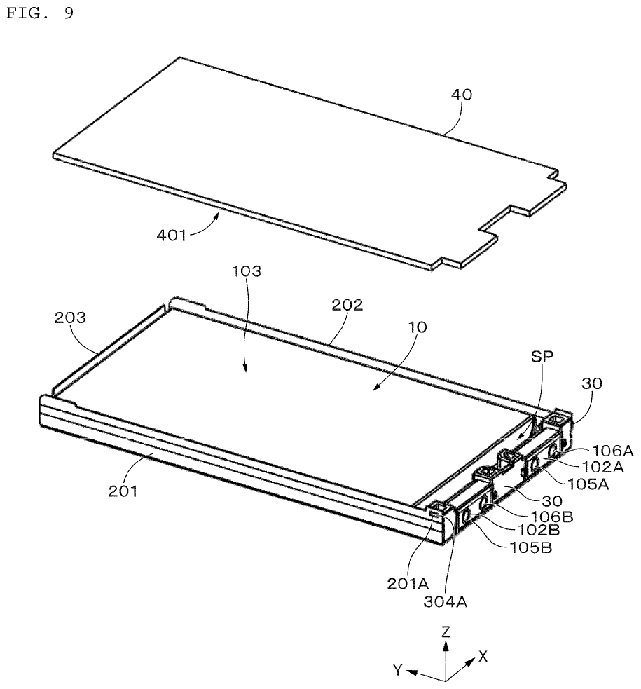

As illustrated in FIGS. 8 and 9, when the holder 30 is installed, a gap SP may arise between the holder 30 and the battery cell 10 equal to a length (a length in the Y direction) to which the positive electrode tab 102A and the negative electrode tab 102B are derived. The gap SP is filled with, for example, molten resin (not illustrated). By curing the resin, the gap SP is filled.

Lastly, the cushion member 40 is attached to an upper surface 103 of the battery cell 10. For example, a double-sided tape is attached to a bottom surface 401 (see FIG. 9) of the cushion member 40. The upper surface 103 of the battery cell 10 and the bottom surface 401 of the cushion member 40 are stuck to each other using the double-sided tape. In this way, the battery unit 1A illustrated in FIGS. 1 and 2 is completed. Of course, the manufacturing method described above is merely an example, and part of a step order may be changed or other steps may be added.

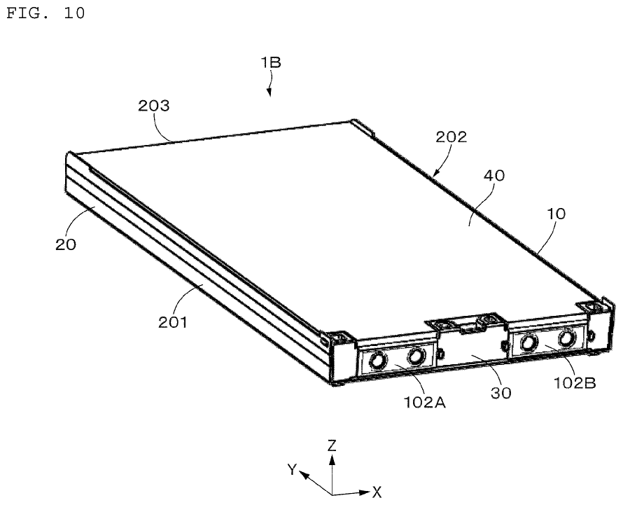

Next, a battery unit 1B, which is a different type to the battery unit 1A, will be described with reference to FIGS. 10 to 14.

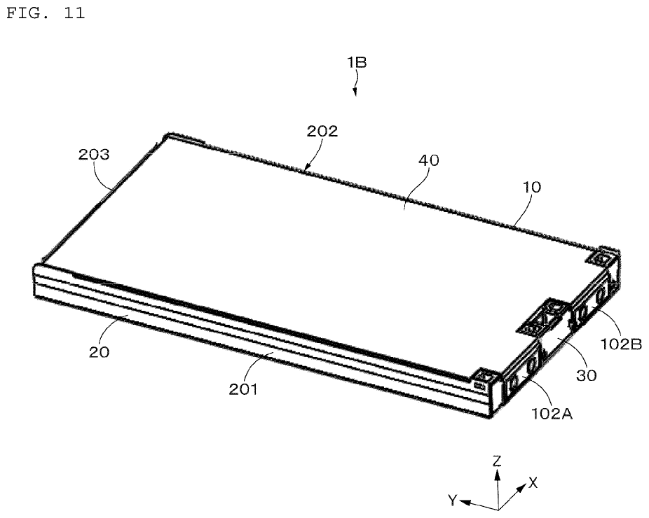

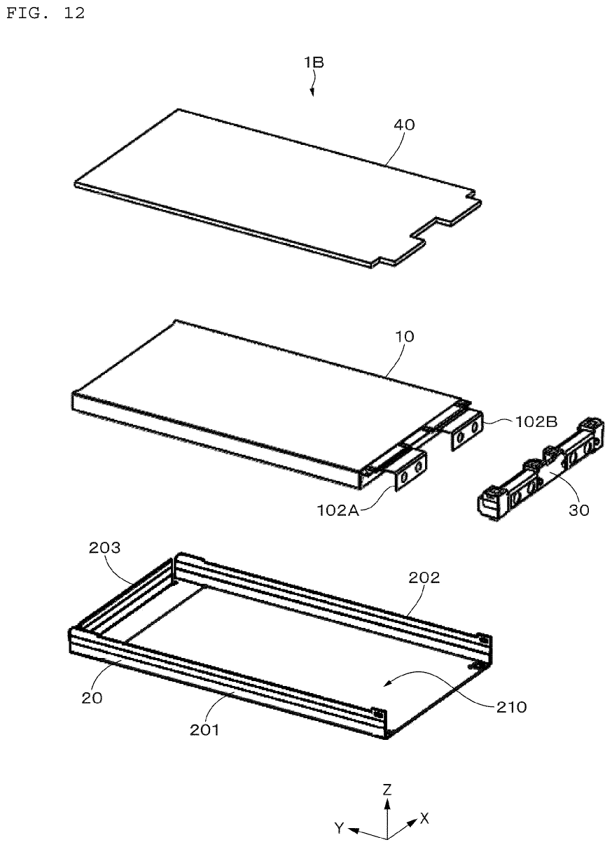

FIGS. 10 and 11 are perspective views of the battery unit 1B according to the embodiment. FIG. 12 is an exploded perspective view of the battery unit 1B according to the embodiment. The configuration including the battery unit 1B is basically the same as the configuration including the battery unit 1A. The battery unit 1B is different from the battery unit 1A in that the battery cell 10 of the battery unit 1B is flipped vertically with respect to the battery cell 10 of the battery unit 1A. As a result, left and right arrangement positions of the positive electrode tab 102A and the negative electrode tab 102B are opposite when viewed from the top side. Other points, for example, the configuration of the metal case 20, the configuration of the holder 30, and the inclusion of the cushion member 40 are the same in both the battery unit 1A and the battery unit 1B.

An example of a manufacturing method for the battery unit 1B will be described with reference to FIGS. 13 to 15. The main steps in the manufacturing method for the battery unit 1B are the same as those of the battery unit 1A. Hereinafter, the manufacturing method will be described focusing on the points of difference.

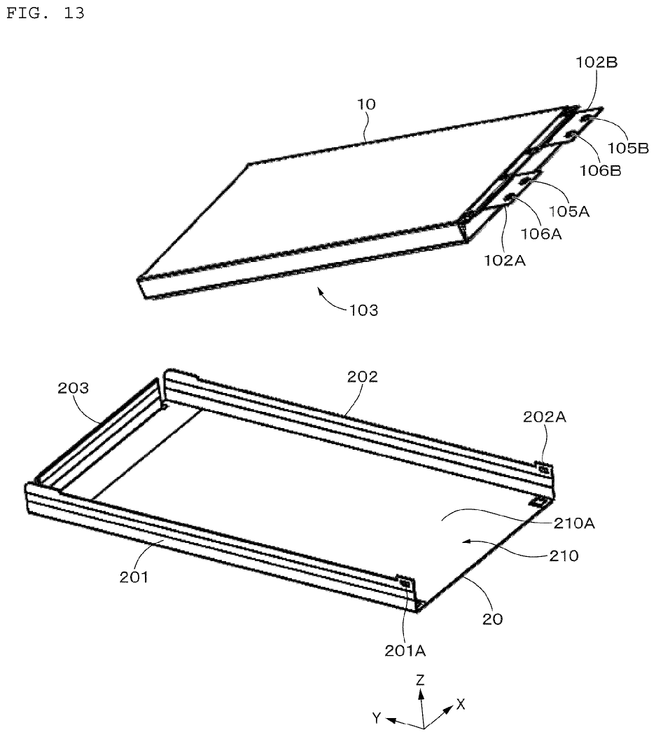

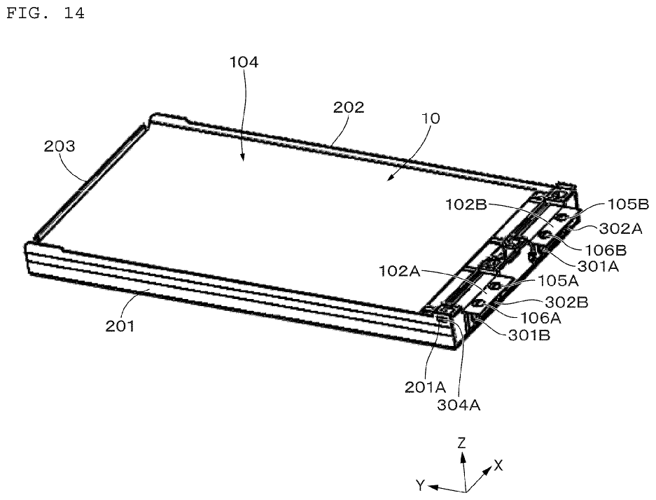

The double-sided tape 210A is adhered to the bottom surface 210 of the metal case 20. The battery cell 10 is stuck to the double-sided tape 210A. The battery cell 10 of the battery unit 1B is flipped vertically with respect to the battery cell 10 of the battery unit 1A. That is, the upper surface 103 of the battery cell 10, which was the upper surface of the battery unit 1A, is the bottom surface. As illustrated in FIG. 13, the bottom surface (the upper surface 103 in the battery unit 1A) is stuck to the double-sided tape 210A. Conversely, as illustrated in FIG. 14, the surface that was the bottom surface of the battery cell 10 of the battery unit 1A is an upper surface 104 of the battery cell 10 of the battery unit 1B. As illustrated in FIG. 15, when the double-sided tape provided on the bottom surface 401 of the cushion member 40 is stuck to the upper surface 104, the battery unit 1B illustrated in FIGS. 13 and 14 is complete.

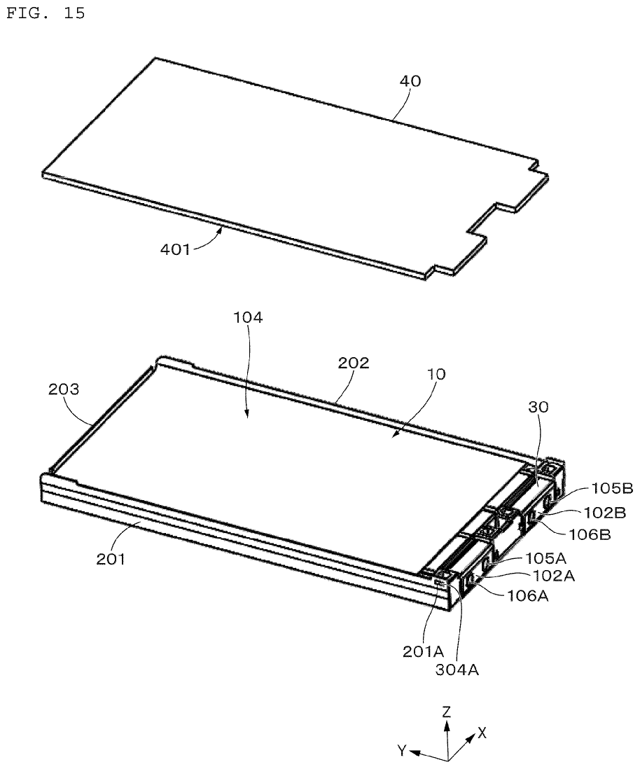

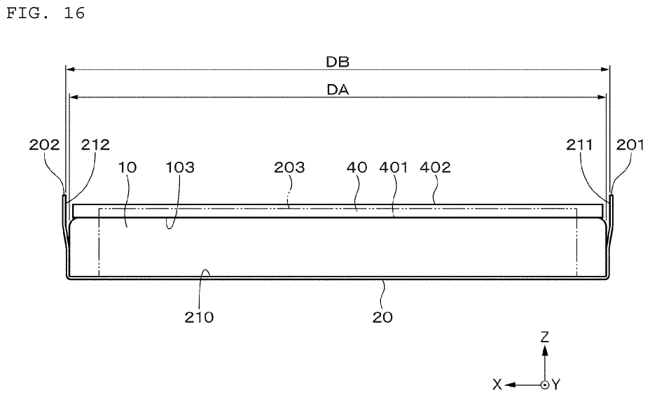

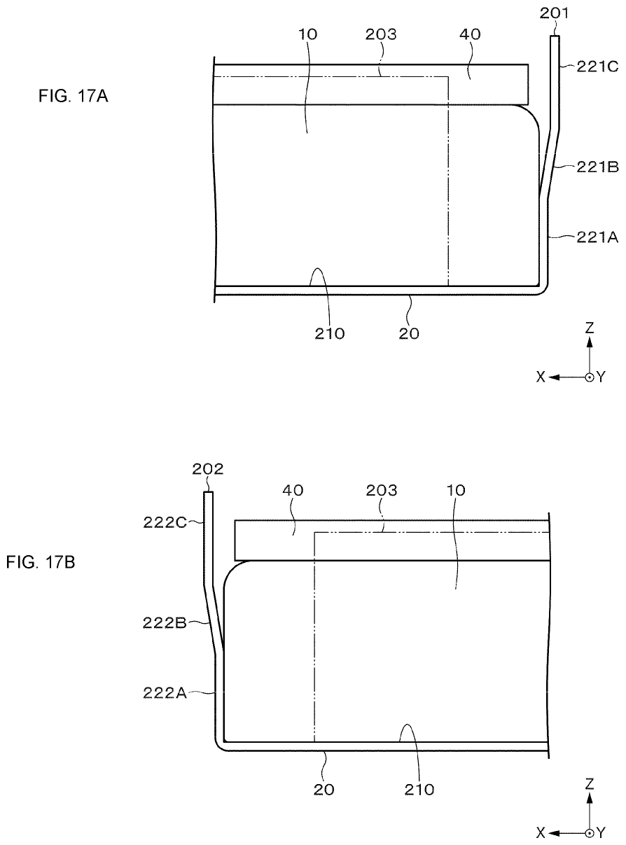

Next, the details of the first side wall 201 and the second side wall 202 will be described with reference to FIGS. 16 and 17. Note that while in the following description, the battery unit 1A will be described as the example, the same applies to the battery unit 1B.

As illustrated in FIG. 16, the first side wall 201 and the second side wall 202 are erected from the peripheral edge of the bottom surface 210 of the metal case 20. As illustrated, a height (a length in the Z direction) of the first side wall 201 and the second side wall 202 is larger than a thickness (the length in the Z direction) of the battery cell 10. That is, the first side wall 201 and the second side wall 202 protrude in the +Z direction further than the upper surface 103 of the battery cell 10 (the upper surface 104 in the case of the battery unit 1B). In addition, the height of the first side wall 201 and the second side wall 202 is larger than a thickness of the battery cell 10 and the cushion member 40. That is, the first side wall 201 and the second side wall 202 protrude in the +Z direction further than an upper surface 402 of the cushion member 40 (a surface on an opposite side to the above-described bottom surface 401).

A thickness (a length in the X direction) of the first side wall 201 and the second side wall 202 is as small as, for example, 0.3 mm. Since the thickness is small, the first side wall 201 and the second side wall 202 function as elastic sections having a spring property. Due to the spring property, the first side wall 201 and the second side wall 202 are displaceable toward an outer side, which is an opposite side to the battery cell 10.

As illustrated in FIG. 17A, the first side wall 201 includes a wall section 221A (an example of a first wall section) erected substantially perpendicular from the bottom surface 210, a bent portion 221B bent from a distal end of the wall section 221A to the outer side on the opposite side to the battery cell 10, and a wall section 221C (an example of a second wall section) extending from a distal end of the bent portion 221B in a direction substantially perpendicular to the bottom surface 210. The wall section 221A, the bent portion 221B, and the wall section 221C are, for example, continuously and integrally formed. Each of these may also be formed separately and integrated by adhesion or the like. A portion above the bent portion, for example, the bent portion 221B and the wall section 221C of the first side wall 201, is displaceable toward the outer side, which is the opposite side to the battery cell 10.

As illustrated in FIG. 17B, the second side wall 202 includes a wall section 222A (an example of a first wall section) erected substantially perpendicular from the bottom surface 210, a bent portion 222B bent from a distal end of the wall section 222A to an outer side on the opposite side to the battery cell 10, and a wall section 222C (an example of a second wall section) extending from a distal end of the bent portion 222B in the direction substantially perpendicular to the bottom surface 210. The wall section 222A, the bent portion 222B, and the wall section 222C are continuously and integrally formed. Each of these may also be formed separately and integrated by adhesion or the like. A portion above the bent portion, for example, the bent portion 222B and the wall section 222C of the second side wall 202, are displaceable toward the outer side, which is the opposite side to the battery cell 10.

As illustrated in FIG. 16, due to the shape of the first side wall 201 and the second side wall 202, a distance between an inner surface 211 of the first side wall 201 and an inner surface 212 of the second side wall 202 becomes larger on an end side (a distance DB, which is an open end side of the metal case 20) that is an opposite side to a side of the bottom surface 210 than on a bottom surface 210 side (a distance DA).

Note that in the present embodiment, as illustrated in FIG. 17A, an inner surface of the wall section 221A on the first side wall 201 and a side surface of the battery cell 10 are in contact with each other. In addition, as illustrated in FIG. 17B, an inner surface of the wall section 222A of the second side wall 202 and a side surface of the battery cell 10 are in contact with each other. While the respective inner surfaces of each wall section and the side surface of the battery cell 10 do not necessarily need to be in contact with each other, the battery cell 10 can be positioned or held by the contact. Consequently, it is preferable that the respective inner surfaces of the wall section 221A and the wall section 222A are in contact with the side surface of the battery cell 10.

Next, the third side wall 203 will be described with reference to FIG. 18. A height and a thickness of the third side wall 203 are substantially the same as those of the first side wall 201 and the second side wall 202. Consequently, the third side wall 203 protrudes in the +Z direction further than the upper surface 103 of the battery cell 10 (the upper surface 104 in the case of the battery unit 1B). In addition, the height of the third side wall 203 is larger than the thickness of the battery cell 10 and the cushion member 40. That is, the third side wall 203 protrudes in the +Z direction further than the upper surface 402 of the cushion member 40 (the surface on the opposite side to the above-described bottom surface 401).

The thickness (the length in the Y direction) of the third side wall 203 is as small as, for example, 0.3 mm. Since the thickness is small, the third side wall 203 functions as an elastic section having a spring property. Due to the spring property, the third side wall 203 is displaceable toward the outer side, which is the opposite side to the battery cell 10.

The third side wall 203 has the same shape as the first side wall 201 and the second side wall 202. That is, as illustrated in FIG. 18, the third side wall 203 includes a wall section 223A (an example of a first wall section) erected substantially perpendicular from the bottom surface 210, a bent portion 223B bent from a distal end of the wall section 223A to the outer side on the opposite side to the battery cell 10, and a wall section 223C (an example of a second wall section) extending from a distal end of the bent portion 223B in the direction substantially perpendicular to the bottom surface 210. The wall section 223A, the bent portion 223B, and the wall section 223C are continuously and integrally formed. Each of these may also be formed separately and integrated by adhesion or the like. The portion above the bent portion, for example, the bent portion 223B and the wall section 223C of the third side wall 203, are displaceable toward the outer side, which is the opposite side to the battery cell 10.

Due to the shape of the third side wall 203, a distance (a distance DD on the end side) between an inner surface of the wall section 223C of the third side wall 203 and the end surface (a bottom-side end surface) of the battery cell 10 is larger than a distance (a distance DC on a bottom surface portion side) between an inner surface of the wall section 223A of the third side wall 203 and the end surface (the bottom-side end surface) of the battery cell 10. Note that from the viewpoint of being able to position and hold the battery cell 10, it is preferable that the inner surface of the wall section 223A is in contact with the bottom-side end surface of the battery cell 10. In other words, it is preferable that the distance DC=0. In addition, a configuration in which the third side wall 203 is separated from the first side wall 201 and the second side wall 202 is preferable from the viewpoint of the spring property. With such a configuration, when the third side wall 203 is displaced, displacement is possible without interfering with the first side wall 201 and the second side wall 202, thus the spring property of the third side wall 203 can be exhibited. The same applies when the first side wall 201 and the second side wall 202 are displaced.

Next, the battery unit assembly will be described. When the battery units 1A and 1B are stacked and electrically connected, the battery unit assembly is completed. When a control board mounted with a control IC and the like is electrically connected to the battery unit assembly, the battery pack is completed. The battery pack is connected to an appropriate load.

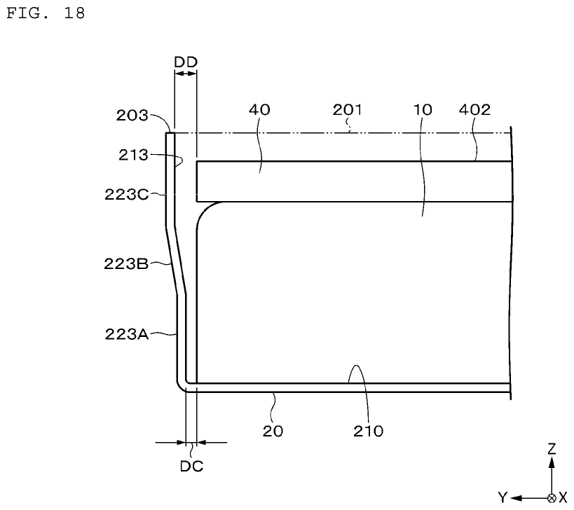

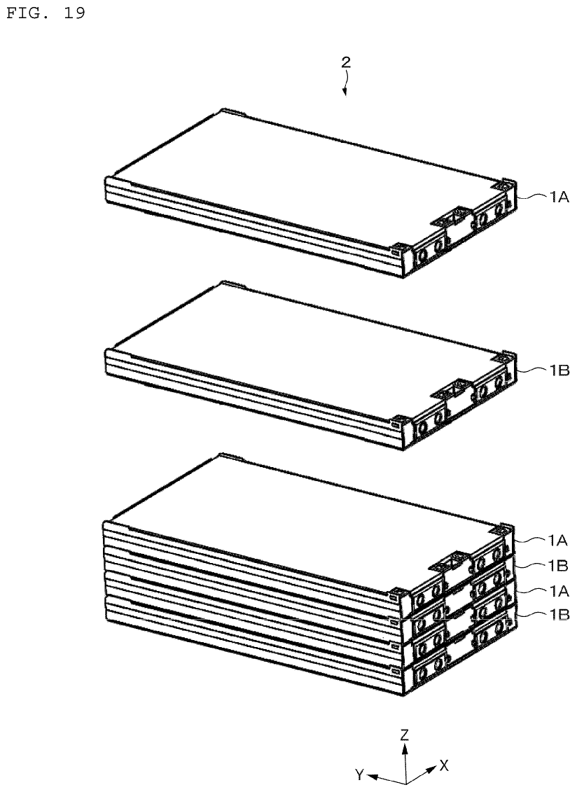

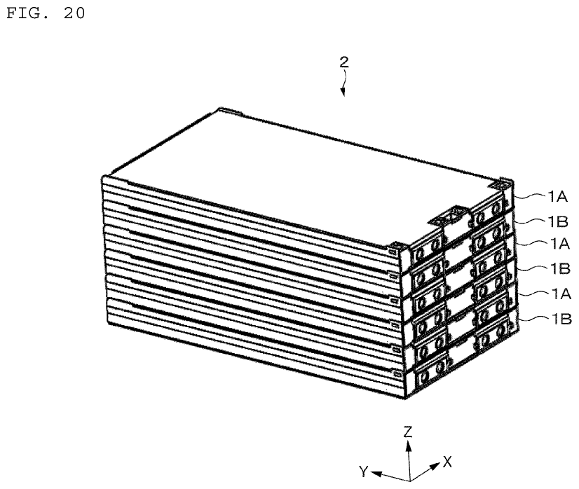

The battery unit assembly (a battery unit assembly 2) according to the present embodiment will be described with reference to FIGS. 19 to 21. As illustrated in FIG. 19, for example, six battery units are stacked. Specifically, a battery unit 1B is arranged on a lowermost side. Then, a battery unit 1A is arranged above the battery unit 1B. After that, the different types of battery units are stacked alternately. For example, six battery units are stacked in the order of 1B, 1A, 1B, 1A, 1B, 1A from the lower side, and though this, the battery unit assembly 2 illustrated in FIG. is formed. More specifically, by applying pressure to an inner side from the vertical direction in a state where the six battery units are stacked, the cushion member 40 of each battery unit is compressed. The six battery units are integrated by the holding members in a compressed state (details will be described later) to form the battery unit assembly 2. Note that in the following description, layers are referred to as a first layer, a second layer, and so on starting from the lower side as appropriate.

Each battery unit constituting the battery unit assembly 2 is electrically connected using, for example, a metal bus bar. Specifically, as illustrated in FIG. 21, the negative electrode tab 102B of the battery unit 1B on the first layer and the positive electrode tab 102A of the battery unit 1A on the second layer are electrically connected by a bus bar 51A. The bus bar 51A is provided with four holes (not illustrated) communicating with the hole 105B and the hole 106B of the negative electrode tab 102B and the hole 105A and the hole 106A of the positive electrode tab 102A. By screwing screws into the holes, the negative electrode tab 102B on the first layer and the positive electrode tab 102A on the second layer are electrically connected. Similarly, the negative electrode tab 102B of the battery unit 1A on the second layer and the positive electrode tab 102A of the battery unit 1B on the third layer are electrically connected by a bus bar 51B. The negative electrode tab 102B of the battery unit 1B on the third layer and the positive electrode tab 102A of the battery unit 1A on the fourth layer are electrically connected by a bus bar 51C. The negative electrode tab 102B of the battery unit 1A on the fourth layer and the positive electrode tab 102A of the battery unit 1B on the fifth layer are electrically connected by a bus bar 51D. The negative electrode tab 102B of the battery unit 1B on the fifth layer and the positive electrode tab 102A of the battery unit 1A on the sixth layer are electrically connected by a bus bar 51E. The positive electrode tab 102A on the first layer and the negative electrode tab 102B on the sixth layer are connected to an external output terminal (not illustrated). The positive electrode tab 102A on the first layer and the negative electrode tab 102B on the sixth layer may also function as the external output terminal. With the connection mode described above, the battery unit assembly 2 in which six battery units are connected in series can be realized. For example, when an output voltage of one battery unit is 4 V, an output voltage of the battery unit assembly 2 according to the present example is 24 V.

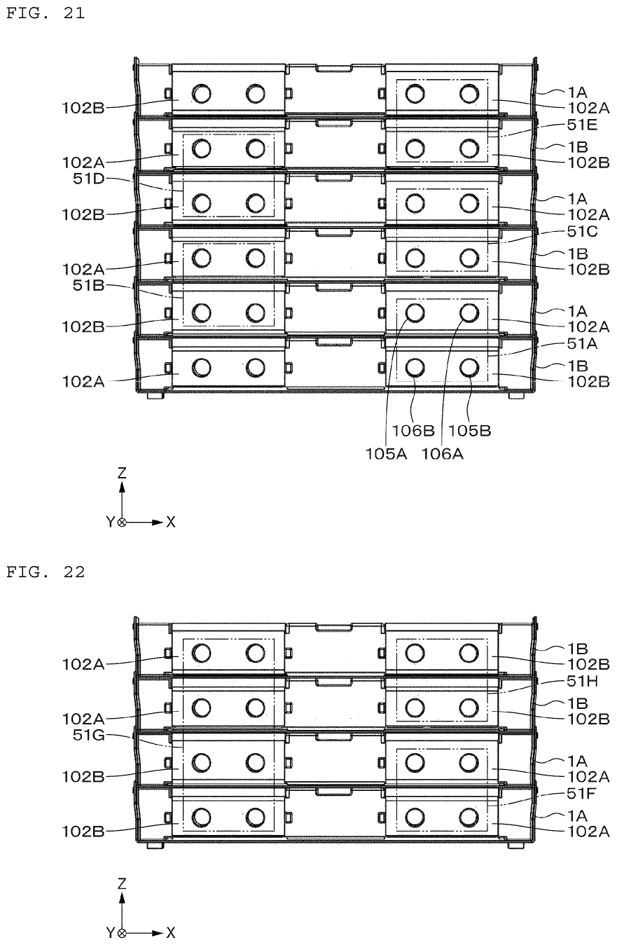

Note that the connection mode of the plurality of battery units can be changed as appropriate. For example, as illustrated in FIG. 22, the battery unit assembly 2 may also have a configuration in which four battery units are stacked. Specifically, the battery unit assembly 2 may also have a configuration in which the battery units are stacked in the order of 1A, 1A, 1B, 1B from the first layer. In such a configuration, the positive electrode tab 102A of the battery unit 1A on the first layer and the positive electrode tab 102A of the battery unit 1A on the second layer are electrically connected by a bus bar 51F. The negative electrode tab 102B of the battery unit 1A on the first layer, the negative electrode tab 102B of the battery unit 1A on the second layer, the positive electrode tab 102A of the battery unit 1B on the third layer, and the positive electrode tab 102A of the battery unit 1B on the fourth layer are electrically connected by a bus bar 51G. The negative electrode tab 102B of the battery unit 1B on the third layer and the negative electrode tab 102B of the battery unit 1B on the fourth layer are electrically connected by a bus bar 51H. With such a connection mode, the battery unit assembly 2 having a two-in-parallel and two-in-series (2P2S) connection can be realized.

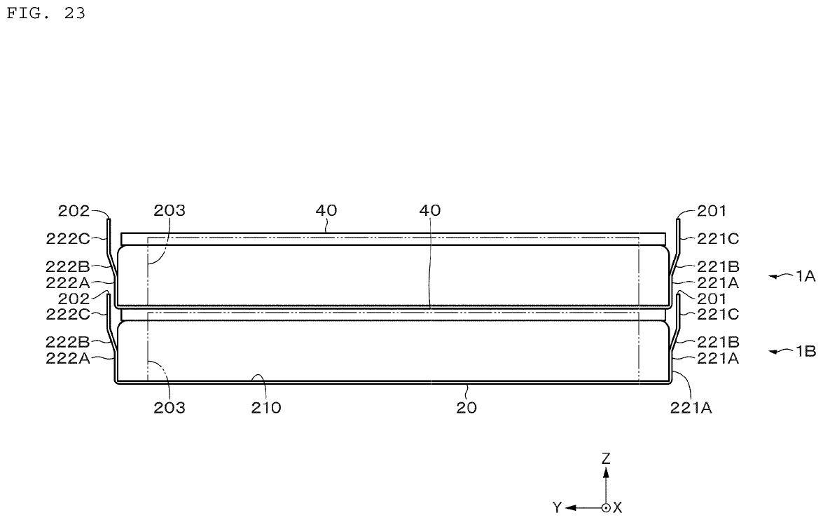

FIG. 23 is a view illustrating two battery units adjacent to each other in the vertical direction (the Z direction) removed from the battery unit assembly 2. The two battery units illustrated in FIG. 23 are, for example, a battery unit 1B on the first layer (an example of the first battery unit) and a second battery unit 1A on the second layer (an example of the second battery unit). Of course, the two battery units may be other battery units (for example, a battery unit 1A on the fourth layer and a battery unit 1B on the fifth layer). In addition, FIG. 23 illustrates, for example, a state where pressure is applied from the vertical direction (or the upward direction) of the six battery units to compress the cushion member 40.

In the state illustrated in FIG. 23, a part of the first side wall 201 of the battery unit 1B on the first layer and a part of the first side wall 201 of the battery unit 1A on the second layer overlap each other. In addition, a part of the second side wall 202 of the battery unit 1B and a part of the second side wall 202 of the battery unit 1A overlap each other.

More specifically, an upper end side inner surface (for example, a part of the inner surface of the wall section 221C) of the first side wall 201 of the battery unit 1B and a lower end side outer surface (for example, a part of the outer surface of the wall section 221A) of the first side wall 201 of the battery unit 1A overlap each other. In addition, an upper end side inner surface (for example, a part of an inner surface of the wall section 222C) of the second side wall 202 of the battery unit 1B and a lower end side outer surface (for example, a part of an outer surface of the wall section 222A) of the second side wall 202 of the battery unit 1A overlap each other. Note that in the present specification, overlapping means that there are areas of overlap when two objects are viewed from a predetermined direction (the Y direction in the present example), and the overlapped areas oppose each other in proximity to each other or are in contact with each other.

In FIG. 23, a part of the first side wall 201 of the battery unit 1B on the first layer and a part of the first side wall 201 of the battery unit 1A on the second layer overlap each other with a slight gap, however they may also be in contact with each other.

By providing the overlapping positions described above, impact resistance and vibration resistance in the battery unit assembly 2 can be improved. For example, it is assumed that a force in the Y direction is applied to the battery units 1B and 1A due to vibration on the battery unit assembly 2. In this case, positional displacement of the battery unit 1A on an upper side can be effectively suppressed by having an overlapping outer side configuration (for example, the first side wall 201 and the second side wall 202 of the battery unit 1B on the first layer) act so as to catch an inner configuration (for example, the first side wall 201 and the second side wall 202 of the battery unit 1A on the second layer). Furthermore, since the first side wall 201 and the second side wall 202 have a spring property and are displaceable toward the outer side, it is possible to effectively suppress positional displacement of the battery unit 1A on the upper side while absorbing vibration and impact. In addition, as described above, as long as the inner surfaces of the wall sections 221A and 222A are brought into contact with the battery cell 10, it is possible to improve vibration resistance while preventing positional displacement of the battery cell 10 without adding any new components.

Note that the example described above is an example in which the cushion member 40 is compressed, however compression is not necessarily required. For example, a configuration may be employed in which overlapping areas occur in a state where pressure is not applied to the battery units 1B and 1A that are stacked, that is, in a state where the cushion member 40 is not compressed. However, regardless of whether or not the cushion member 40 is compressed, it is preferable that the overlapping position does not include a bent portion. This is because when a position with a bent portion is included, there is a high risk of the first side wall 201 and the second side wall 202 positioned on the lower side becoming deformed or damaged when impact or vibration is applied.

In addition, while not illustrated, the same applies to the respective third side walls 203 of each of the upper and lower battery units. That is, by also providing an overlapping position on the upper and lower third side walls 203, it is possible to effectively suppress vibration and impact applied in the X direction.

When the six battery units constituting the battery unit assembly 2 are only stacked, the battery units may fall off or the like. Consequently, in the present embodiment, the six battery units are firmly fixed using a holding member. Hereinafter, a plurality of examples of holding members included in the battery unit assembly 2 and an example of a method for fixing the six battery units will be described.

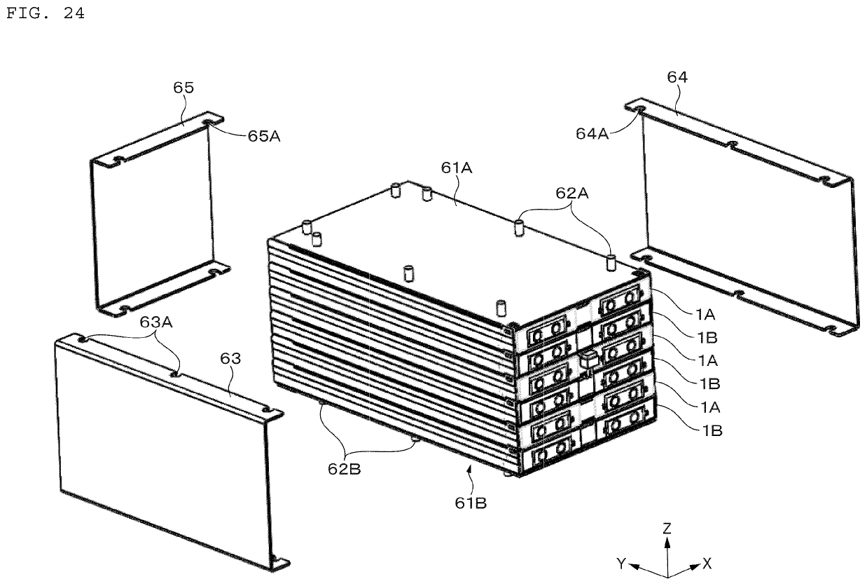

A first example of the holding member will be described with reference to FIGS. 24 to 26. The holding member according to the first example includes metal plates 61A and 61B. The metal plate 61A is placed on the upper surface of the battery unit 1A arranged at the uppermost portion. A plurality (in the present example, eight) of protrusions 62A are provided on a peripheral edge of an upper surface of the metal plate 61A. Two protrusions 62A are provided on the peripheral edge in the X direction (the peripheral edge on the bottom side), and three protrusions 62A are respectively provided on each peripheral edge in the Y direction. The metal plate 61B is arranged on the bottom surface of the battery unit 1B arranged at the lowermost portion. A plurality (in the present example, eight) of protrusions 62B are provided on a peripheral edge of a bottom surface of the metal plate 61B. In the same manner as the protrusions 62A, two protrusions 62B are provided on the peripheral edge in the X direction (the peripheral edge on the bottom side), and three protrusions 62B are respectively provided on each peripheral edge in the Y direction. The metal plates 61A and 61B function as protection plates for protecting the upper and lower surfaces of the six battery units that are stacked.

In addition, the holding member according to the first example includes metal plates 63, 64, and 65. A shape of an end surface of the metal plate 63 when viewed from the Y direction is U-shaped. Three semicircular cutouts 63A are respectively provided on each of two opposing wall sections of the metal plate 63. A shape of an end surface of the metal plate 64 when viewed from the Y direction is U-shaped. Three semicircular cutouts 64A are respectively provided on each of two opposing wall sections of the metal plate 64. A shape of an end surface of the metal plate 65 when viewed from the X direction is U-shaped. Two semicircular cutouts 65A are respectively provided on each of two opposing wall sections of the metal plate 65.

The metal plates 63, 64, and 65 are fitted in a state where pressure is applied toward an inner side from the vertical direction to the six battery units, that is, in a state where the cushion member 40 of each battery unit is compressed. The metal plates 63 and 64 are fitted into a side surface substantially orthogonal to the surface from which the tabs are exposed, and the metal plate 65 is fitted into a surface on an opposite side to the surface from which the tabs are exposed. Specifically, each metal plate is fitted into the protrusions 62A and 62B corresponding to the cutouts of the metal plates. The metal plates 63, 64, and 65 are brought into close contact with the six battery units by a restoring force of the compressed cushion members 40, thereby integrating the six battery units as illustrated in FIG. 25.

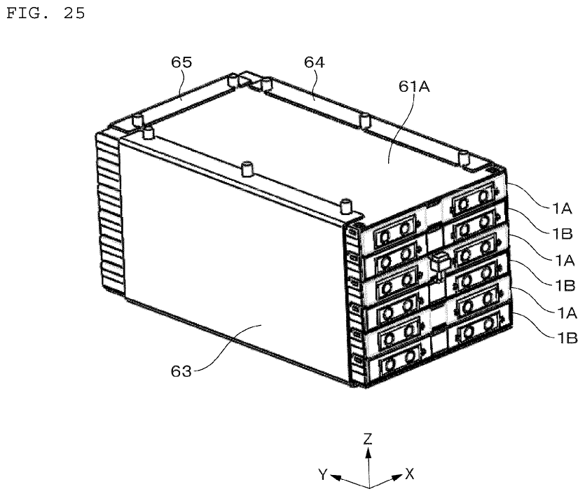

The protrusions 62A and the protrusions 62B become external threads formed of threads, and the metal plates 63, 64, and 65 and the six battery units are brought more firmly in close contact with each other as illustrated in FIG. 26 by screwing nuts 67 into the protrusions 62A and the protrusions 62B, thereby integrating the six battery units.

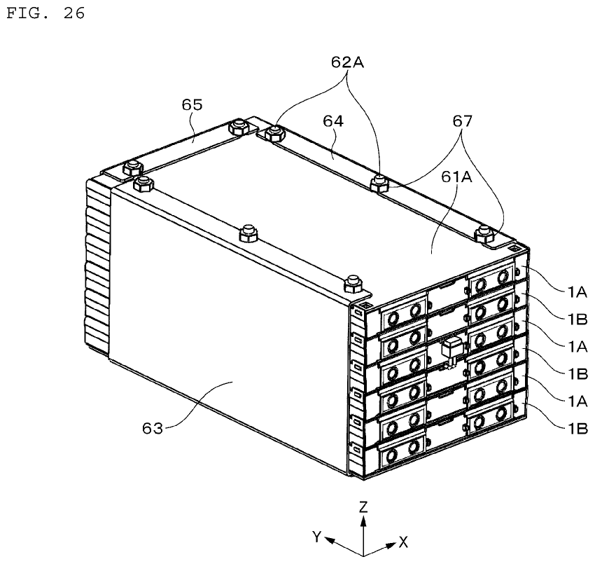

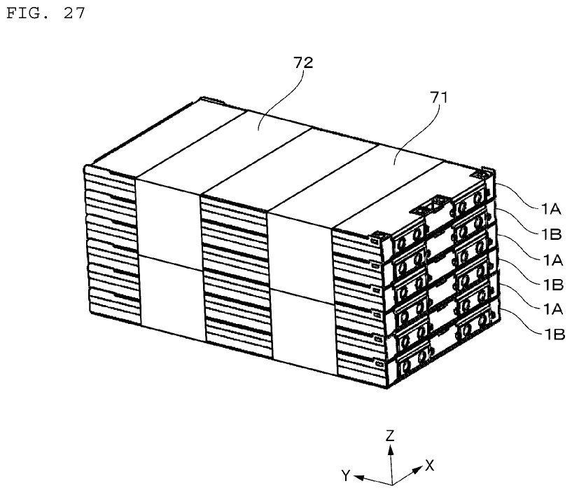

A second example of the holding member will be described with reference to FIG. 27. As illustrated in FIG. 27, the holding member may be band members 71 and 72 attached around the six battery units to bind the six battery units. Note that there may be a single band member, or three or more may be used.

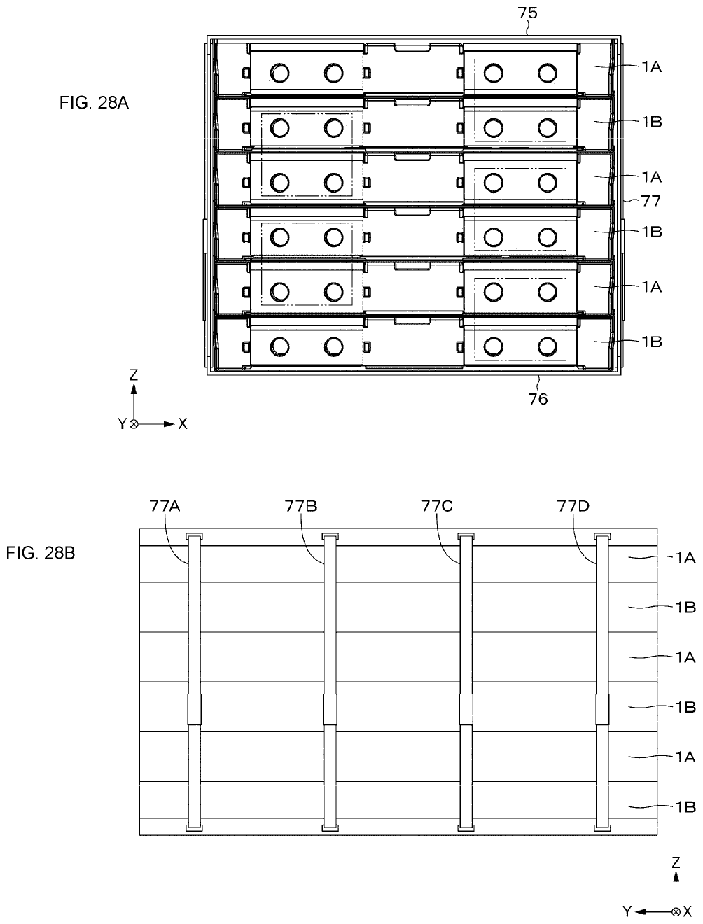

A third example of the holding member will be described with reference to FIGS. 28A and 28B. As illustrated in FIG. 28A, exterior plates 75 and 76 are arranged above and below the six battery units. A metal plate or a resin plate can be used as the exterior plates 75 and 76. A band member 77, which is an example of a connecting member, is attached to the exterior plates 75 and 76. The band member 77 is inserted into the exterior plates 75 and 76, and is wound around an entire periphery of the battery unit assembly 2. As illustrated in FIG. 28B, the band member 77 includes, for example, four band members 77A to 77D. A length of the band member 77 is adjustable, and by adjusting the length as appropriate, the six battery units are fixed while being compressed toward an inner side by the exterior plates 75 and 76.

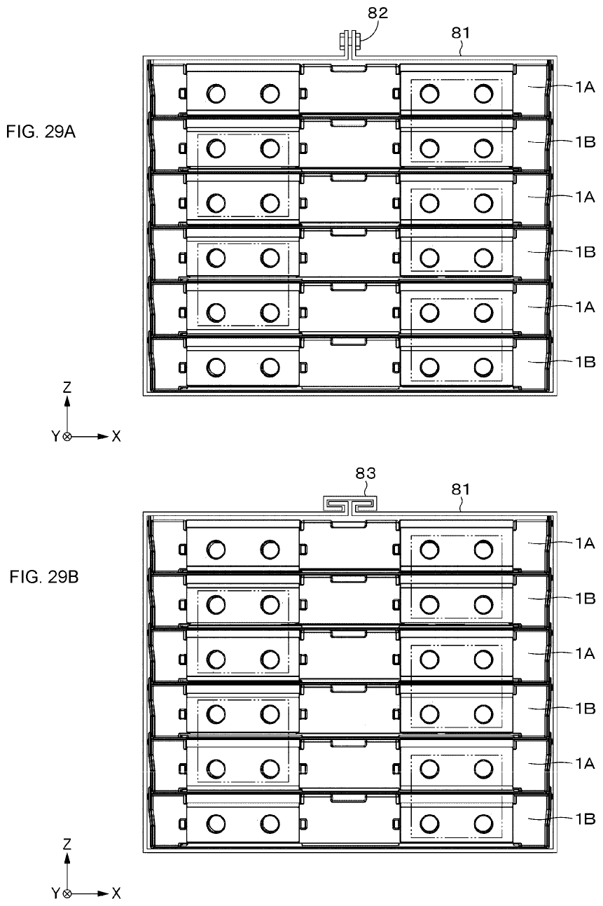

A fourth example of the holding member will be described with reference to FIGS. 29A and 29B. As illustrated in FIG. 29A, six battery units are stored so as to be wrapped by a storage member 81 while the cushion member 40 of each battery unit is compressed. A metal box or a resin box can be used as the storage member 81. The storage member 81 is closed by screwing a screw 82 into the storage member 81. Note that, as illustrated in FIG. 29B, the storage member 81 may also be closed by being fixed by a publicly known locking part 83.

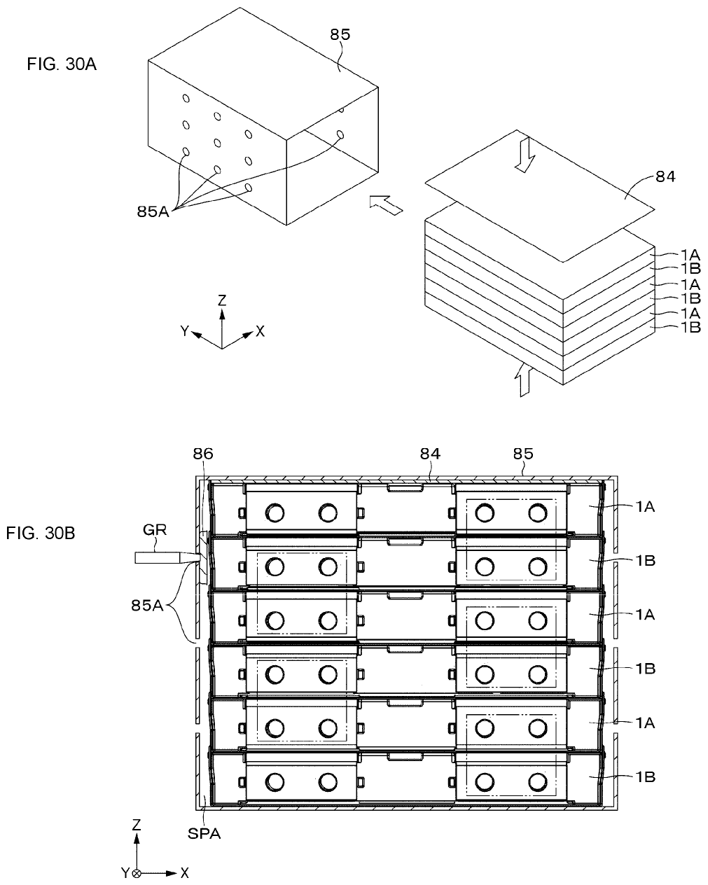

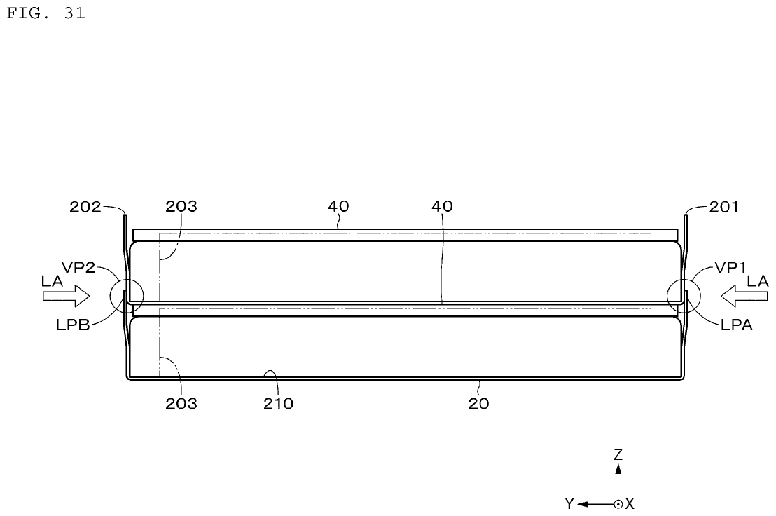

A fifth example of the holding member will be described with reference to FIGS. 30A and 30B. As illustrated in FIG. a metal plate 84 is arranged on an upper side of the six battery units. The six battery units are compressed using the metal plate 84 while the six battery units and the metal plate 84 are stored in a metal box 85. An appropriate number of holes 85A are provided around the box 85. The metal plate 84 also serves as a protection plate protecting the cushion member 40 and the like positioned at the uppermost portion of the six battery units.

FIG. 30B illustrates a section in a state where the six battery units and the metal plate 84 are stored in the box Note that in FIG. 30B, surfaces where tabs are exposed are illustrated for six battery units for convenience of description. As illustrated in FIG. 30B, a bond or a liquid resin (hereinafter collectively referred to as a resin GR as appropriate) is injected inside the box 85 from one of the holes 85A. The resin GR is injected through the other holes in the same way. When the resin GR or the like injected inside the interior cures, adhesion portions 86 are formed in spaces SPA between each battery units an inner surface of the box 85. The inner surface of the box 85 and outer surfaces of the six battery units are bonded by adhesion portions 86, thereby fixing the six battery units to the box 85.

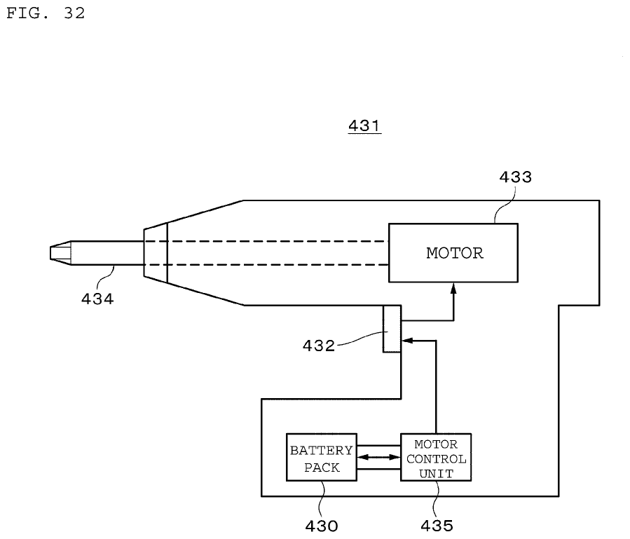

Next, a sixth example will be described with reference to FIG. 31. The sixth example is an example in which the six battery units are fixed without using a holding member. As illustrated in FIG. 31, a position where the first side walls 201 overlap (hereinafter, the position is referred to as an overlapping portion VP1 as appropriate) is present between the upper and lower battery units. In addition, a position where the second side walls 202 overlap (hereinafter, this position is referred to as an overlapping portion VP2 as appropriate) is present between the upper and lower battery units. Laser welding is performed by irradiating each of the overlapping portion VP1 and the overlapping portion VP2 with a laser LA. Laser welding marks (laser marks) LPA and LPB are formed on each of the overlapping portion VP1 and the overlapping portion VP2 by the laser welding. Laser welding is also performed on other overlapping portions in the same way. The six battery units are integrally fixed by welding each overlapping portion. Note that, while not illustrated, laser welding may also be performed on an overlapping portion of the third side wall 203.

Note that the plurality of examples described above may be combined. For example, laser welding may be performed on the overlapping portions, and the six battery units subjected to laser welding may be stored in the box 85.

While an embodiment of the present disclosure has been described herein, the contents of the present disclosure are not limited thereto, and thus suitable modifications are contemplated.

In the battery cell in an embodiment, derivation directions of the positive electrode tab and the negative electrode tab are the same direction, however the extraction directions may be different directions, such as opposite sides or the like. In this case, a configuration without a third side wall may be used.

In an embodiment described above, the first side wall and the second side wall are separated from the third side wall, however each of the side walls may be integrally formed. However, as described above, a configuration in which the first side wall and the second side wall are separated from the third side wall is preferable.

It is preferable that the battery units include cushion members to protect the battery cells, however the cushion members may be omitted. In addition, a number, etc. of battery units constituting the battery unit assembly may be changed as appropriate. Moreover, battery cells other than the laminate type may be used as the battery cells.

The matters described in the above-described embodiment and modified examples can be combined as appropriate. In addition, the materials, processes, and the like described in an embodiment are merely examples, and the contents of the present disclosure are not limited thereto.

The battery unit, the battery unit assembly, or the battery pack (hereinafter referred to as a battery unit, etc. as appropriate) using the battery unit or the battery unit assembly can be used for mounting onto or to supply electric power to a power tool, an electric vehicle, various electronic devices, or the like.

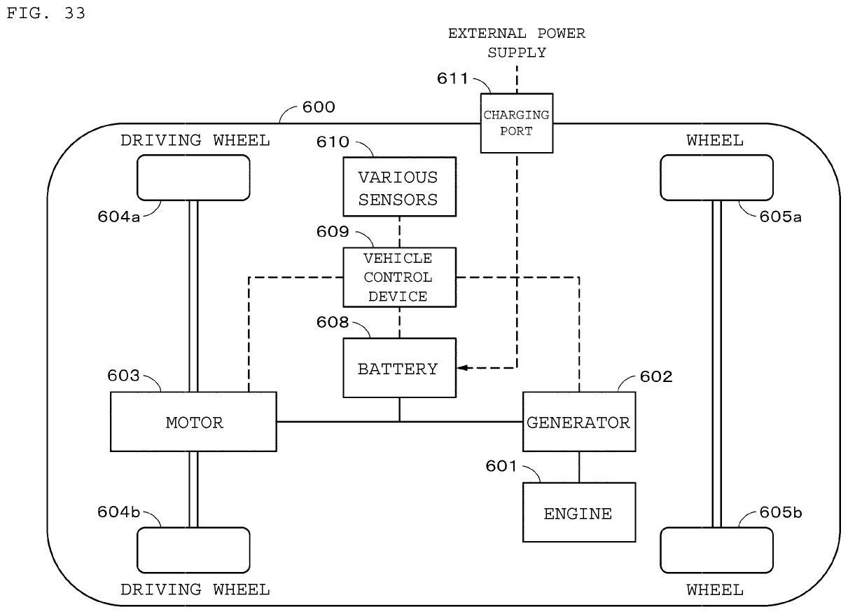

An example of an electric screwdriver as a power tool to which the present disclosure can be applied will be schematically described with reference to FIG. 32. An electric screwdriver 431 is provided with a motor 433 that transmits rotational power to a shaft 434, and a trigger switch 432 that is operated by a user. A battery pack 430 and a motor control unit 435 are housed in a lower housing of a handle of the electric screwdriver 431. The battery pack 430 is built in the electric screwdriver 431, or is detachable. The battery unit, etc. described above may be applied to the battery pack 430.

The battery pack 430 and the motor control unit 435 may each be provided with a microcomputer (not illustrated) so that charge/discharge information of the battery pack 430 can be communicated between them. The motor control unit 435 can control operation of the motor 433 and cut off power supply to the motor 433 during a malfunction, such as over discharge or the like.

FIG. 33 schematically shows a configuration example of a hybrid vehicle (HV) employing a series hybrid system as an example in which the present disclosure is applied to an electric storage system for an electric vehicle. The series hybrid system is a vehicle traveling by an electric power driving force converter using electric power generated by a generator powered by an engine, or electric power from temporarily storing the generated electric power in a battery.

A hybrid vehicle 600 is mounted with an engine 601, a generator 602, an electric power driving force converter (a direct-current motor or an alternate-current motor; hereinafter, simply referred to as “motor 603”), a driving wheel 604a, a driving wheel 604b, a wheel 605a, a wheel 605b, a battery 608, a vehicle control device 609, various sensors 610, and a charging port 611. The battery unit, etc. of the present disclosure can be applied as the battery 608.

The motor 603 is operated by electric power of the battery 608, and a rotating force of the motor 603 is transmitted to the driving wheels 604a and 604b. Electric power generated in the generator 602 by the rotating force produced by the engine 601 can be stored in the battery 608. The various sensors 610 control an engine revolution speed via the vehicle control device 609 and control an opening degree of a throttle valve (not illustrated).

When the hybrid vehicle 600 decelerates by a braking mechanism (not illustrated), a resistance force during the deceleration is applied as a rotating force to the motor 603, and regenerative electric power generated due to the rotating force is stored in the battery 608. The battery 608 can be charged by being connected to an external power supply via the charging port 611 of the hybrid vehicle 600. Such a HV vehicle is referred to as a plug-in hybrid vehicle (PHV or PHEV).

Note that the battery unit or the battery unit assembly according to the present disclosure can also be applied to a compact primary battery and used as a power supply of a tire pressure monitoring system (TPMS) built in the wheels 604 and 605.

While a series hybrid vehicle has been described above as an example, the present disclosure can also be applied to a hybrid vehicle having a parallel system that uses both an engine and a motor or having a combination of a series system and a parallel system. Moreover, the present disclosure can also be applied to an electric vehicle (EV or BEV) that travels using a drive motor only without using an engine, and a fuel cell vehicle (FCV).

### DESCRIPTION OF REFERENCE SYMBOLS

1A, 1B: Battery unit
2: Battery unit assembly
10: Battery cell
20: Metal case
40: Cushion member
71, 72, 77: Band member
85: Box
86: Adhesion portion
103, 104: Upper surface
201: First side wall
202: Second side wall
203: Third side wall
210: Bottom surface of metal case
221A, 222A, 223A: Wall section
221B, 222B, 223B: Bent portion
221C, 222C, 223C: Wall section
401: Upper surface of cushion member
DA, DB, DC, DD: Distance
LPA, LPB: Laser welding mark

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery unit comprising:
a battery cell; and
a metal case in which the battery cell is stored, the metal case including a bottom surface, and a first side wall and a second side wall erected from a peripheral edge of the bottom surface and having inner surfaces opposed to each other, wherein
the first side wall and the second side wall protrude further than an upper surface of the battery cell, and
a distance between an inner surface of the first side wall and an inner surface of the second side wall is larger on an end side, which is an opposite side to a bottom surface side, than on the bottom surface side.

2. The battery unit according to claim 1, wherein
the metal case includes a third side wall extending in a direction substantially orthogonal to an extending direction of the first side wall and the second side wall,
an inner surface of the third side wall opposes a predetermined end surface of the battery cell, and
a distance between the inner surface of the third side wall and the predetermined end surface of the battery cell is larger on the end side than on the bottom surface side.

3. The battery unit according to claim 1, wherein a cushion member is provided on the upper surface of the battery cell.

4. The battery unit according to claim 3, wherein the first side wall and the second side wall protrude from an upper surface of the cushion member.

5. The battery unit according to claim 1, wherein each of the side walls has a spring property.

6. The battery unit according to claim 5, wherein each of the side walls is displaceable toward an outer side, which is the opposite side to the battery cell.

7. The battery unit according to claim 1, wherein each of the side walls includes a bent portion that is bent toward the outer side, which is the opposite side to the battery cell.

8. The battery unit according to claim 1, wherein a bottom surface side inner surface of the first side wall and a bottom surface side inner surface of the second side wall are in contact with the battery cell.

9. The battery unit according to claim 1, wherein each of the side walls includes a first wall section erected from the bottom surface, a bent portion bent from a distal end of the first wall section toward the opposite side to the battery cell, and a second wall section extending from a distal end of the bent portion.

10. The battery unit according to claim 9, wherein the bent portion and the second wall section are displaceable toward the outer side, which is the opposite side to the battery cell.

11. A battery unit assembly comprising:
a plurality of the battery units according to claim 1, wherein
a first battery unit and a second battery unit among the plurality of battery units are stacked,
a part of the first side wall of the first battery unit and a part of the first side wall of the second battery unit overlap each other, and
a part of the second side wall of the first battery unit and a part of the second side wall of the second battery unit overlap each other.

12. The battery unit assembly according to claim 11, wherein an upper end side inner surface of the first side wall of the first battery unit and a lower end side outer surface of the first side wall of the second battery unit overlap each other, and an upper end side inner surface of the second side wall of the first battery unit and a lower end side outer surface of the second side wall of the second battery unit overlap each other.

13. The battery unit assembly according to claim 11, wherein a protection plate is provided on an upper portion of the battery unit arranged at an uppermost portion.

14. The battery unit assembly according to claim 11 comprising a holding member that holds the plurality of battery units.

15. The battery unit assembly according to claim 14, wherein the holding member is a band member attached around the plurality of battery units.

16. The battery unit assembly according to claim 14, wherein the holding member includes exterior plates arranged above and below the plurality of battery units, and a band member connecting the exterior plates.

17. The battery unit assembly according to claim 14, wherein the holding member includes a storage member that stores the plurality of battery units.

18. The battery unit assembly according to claim 17 comprising adhesion portions provided between the storage member and each of the plurality of battery units.

19. The battery unit assembly according to claim 11, wherein a laser welding mark is formed on the overlapping positions.

20. A power tool comprising the battery unit according to claim 1.

21. An electric vehicle comprising the battery unit according to claim 1.
